(19) United States
(12) Patent Application Publication
(10) Pub. No.: US 2024/0230243 A1
(43) Pub. Date: Jul. 11, 2024

(54) WASTEWATER HEAT RECOVERY SYSTEMS

(71) Applicant: KOHLER MIRA LIMITED, Cheltenham (GB)

(72) Inventors: Sean Conway, Cheltenham (GB); Oliver Jones, Cheltenham (GB); Steven Richard Sandell, Cheltenham (GB); James Cranwell, Cheltenham (GB); Bradley Edwards, Cheltenham (GB)

(21) Appl. No.: 18/408,097

(22) Filed: Jan. 9, 2024

Related U.S. Application Data
(60) Provisional application No. 63/479,210, filed on Jan. 10, 2023.

(51) Int. Cl. F28F 1/04

(52) U.S. Cl. CPC F28F 1/04

(57) ABSTRACT

The heat exchanger tray provided herein may include a base, a cover, and a heat exchange coil. The base may include a cutout and a bottom portion with one or more sidewalls forming a serpentine path for wastewater. The cover may be positioned within the cutout of the base to create a space between the base and the cover. The cover may include one or more protruding portions that engage with the one or more sidewalls of the bottom portion of the base to enclose the serpentine path. The heat exchange coil may be positioned in and along at least a portion of the serpentine path between the base and the cover. Fresh water may flow through the heat exchange coil. Wastewater may flow through the serpentine path between the base and the cover, such that the wastewater may heat the fresh water flowing through the heat exchange coil.

### CROSS-REFERENCE TO RELATED APPLICATIONS

The present application claims priority to U.S. Provisional Patent Application No. 63/479,210, filed Jan. 10, 2023, entitled, “WASTEWATER HEAT RECOVERY SYSTEMS,” the entire contents of which are hereby incorporated by reference.

### BACKGROUND

This application relates generally to a heat exchange tray. More specifically, this application relates to a heat exchange tray configured to recover heat from shower wastewater to increase the temperature of water traveling to the shower.

### BRIEF DESCRIPTION OF DRAWINGS

FIG. 1 is a perspective view of an example heat exchange tray.

FIG. 2 is a perspective view of an example cover.

FIG. 3 is a cross-sectional view of an example heat exchange tray.

FIG. 4 is a cross-sectional view of an example heat exchange coil placed within an example heat exchange tray.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

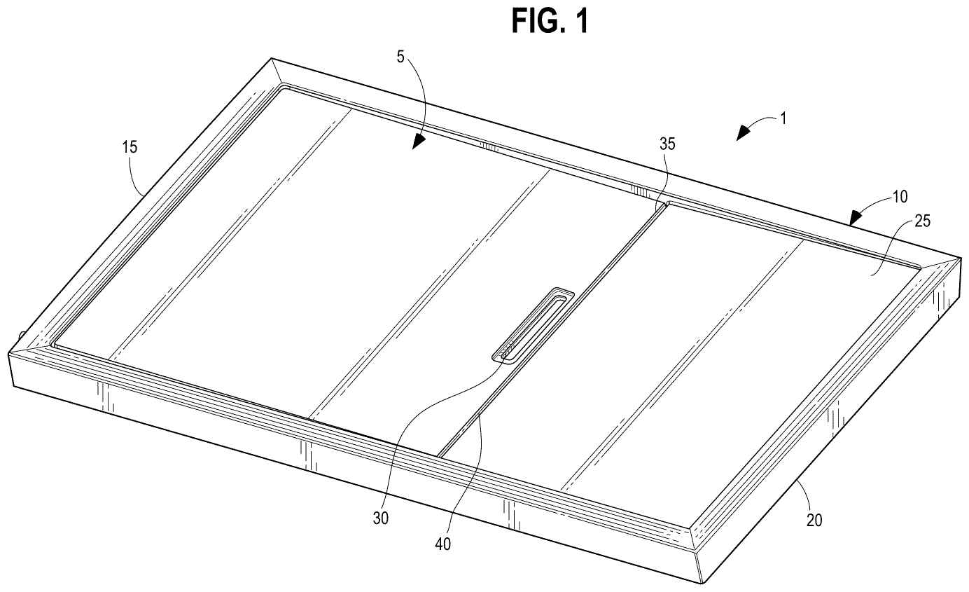

Turning first to FIG. 1, a heat exchange tray 1 may be provided for a user to stand on when showering. The heat exchange tray 1 may include a cover 5 which may sit atop or be inset within a base 10 of the heat exchange tray 1. The base 10 may include a cutout configured to receive the cover 5. The cover 5 may attach to or be integrally formed with the base 10. When water flows on the heat exchange tray 1 during a shower, water may flow via gravity from each of a first end 15 and a second end 20 of the heat exchange tray 1. Water may flow via gravity down the cover 5 and a sloped portion 25 of the base 10. Water may flow toward a heat chamber inlet 30 to enter a heat exchange chamber (not illustrated, as the heat exchange chamber is covered by the cover 5). In alternative embodiments, heat chamber inlet 30 may be positioned near or at the first end 15 or second end 20. In such an embodiment, the cover 5 may extend most or all of the length of the base 5 such that sloped portion 25 is smaller or not present.

The heat chamber inlet 30 may be placed near an end 35 of the cover 5. The end 35 of the cover 5 may be on an opposite side of the cover 5 relative to the first end 15 of the heat exchange tray 1. The heat chamber inlet 30 may be positioned near a connection point 40 of the cover 5 and the sloped portion 25 of the base 10. The heat chamber inlet 30 may be positioned in any suitable manner, such that gravity causes water to flow toward and into the heat chamber inlet 30.

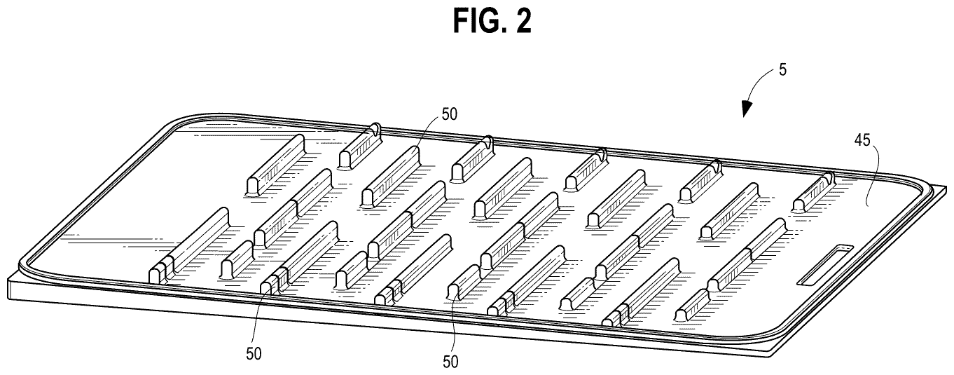

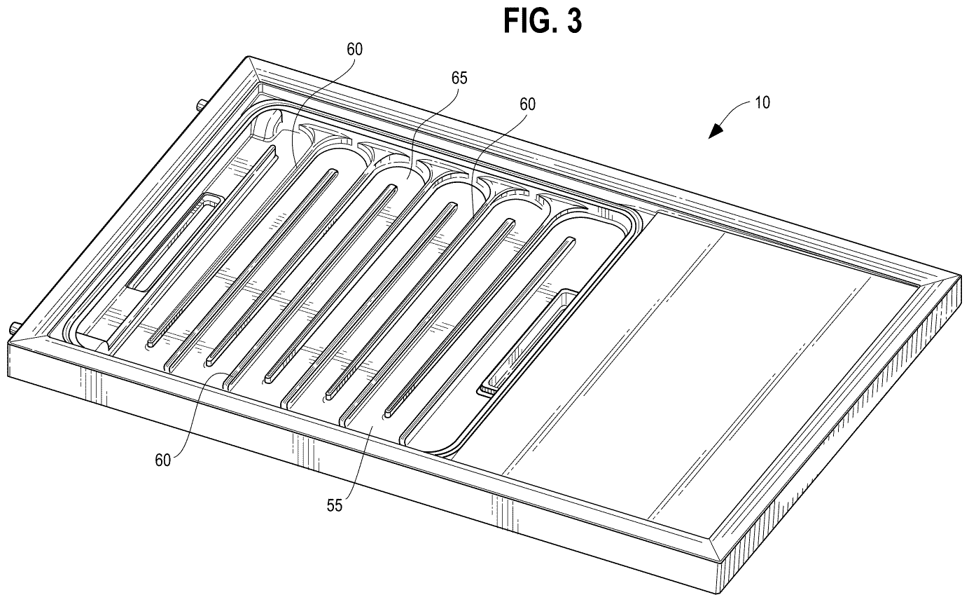

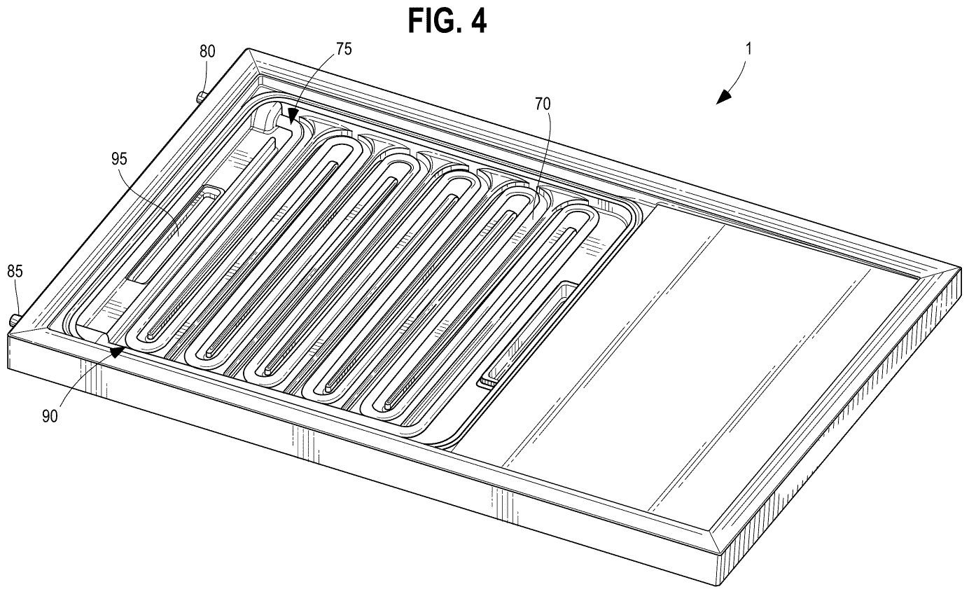

As illustrated in FIG. 2, an underside 45 of the cover 5 may include a plurality of protruding portions 50, which may be flow-directing features. The protruding portions 50 may be positioned in such a way that the base 10 may be integrated with the cover 5. As illustrated in FIG. 3, a bottom portion 55 of the base 10 may include one or more sidewalls 60 which may form a path 65. The protruding portions 50 of FIG. 2 may engage with the sidewalls 60 of the path 65 of FIG. 3 in order to form a wastewater flow path 70, as illustrated in FIG. 4. Such engagement may take the form of an abutting relationship, or the protruding portions 50 may fit with or around the sidewalls 60 to form such engagement.

Turning now to FIG. 4, a heat exchange coil 75 may carry water to be heated. Water may enter the heat exchange coil 75 via an inlet 80 and may flow out of the heat exchange coil 75 via an outlet 85. The inlet 80 and outlet 85 may be switched such that the water enters and exits the tray 1 from opposite sides of the tray 1.

The heat exchange coil 75 may be positioned along the wastewater flow path 70. The heat exchange coil 75 may “snake” along the wastewater flow path 70 and may be fitted along the wastewater flow path 70. The heat exchange coil 75 may be any suitable length to fit the wastewater flow path 70. The heat exchange coil 75 may connect to, be attached to, or be integrally formed with the wastewater flow path 70 in any suitable manner. The heat exchange coil 75 may be made of copper or any other suitable material with beneficial heat transfer qualities. Using copper or another material with desirable heat transfer properties for the heat exchange coil 75 may improve the effectiveness of heat transfer.

When the cover 5 is attached to or placed within the base 10, water may enter a heat exchange chamber 90 via the heat chamber inlet 30. The heat exchange chamber 90 may be formed by the heat exchange coil 75 fitted along the wastewater flow path 70. Fresh water may flow into and through the heat exchange coil 75. When flowing through the heat exchange coil 75 in the heat exchange chamber 90, fresh water in the heat exchange coil 75 may be heated by the wastewater flowing along the wastewater flow path 70. The heat exchange coil 75 may therefore be positioned between a freshwater inlet and an ablutionary fitting. After passing through the heat exchange chamber 90, water may exit the heat exchange tray 1 via a wastewater outlet 95. A waste trap fitment or filter may be placed at the wastewater outlet 95 in order to collect or remove waste from the wastewater.

There may be a void beneath the heat exchange chamber 90, which may act as still air gap insulation or may be filled with an insulating material including but not limited to a foamed polymer or other insulation. The insulating material may serve as a mechanism to enhance heat exchange between the wastewater and the water flowing through the heat exchange coil 75. The insulation may assist with heat transfer by reducing losses of heat to the atmosphere or building structure, and/or act as a safety feature to prevent leaks. The insulation may be expansive foam or a molded insert.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations, and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations, and other uses and applications which do not depart from the spirit and scope of the present inventions are deemed to be covered by the inventions which are limited only by the claims which follow.

1. A heat exchanger tray comprising:
a base comprising a cutout, the base including a bottom portion with one or more sidewalls forming a serpentine path for wastewater;
a cover positioned within the cutout of the base to create a space between the base and the cover, the cover including one or more protruding portions that engage with the one or more sidewalls of the bottom portion of the base to enclose the serpentine path; and
a heat exchange coil positioned in and along at least a portion of the serpentine path between the base and the cover;
wherein fresh water flows through the heat exchange coil; and
wherein wastewater flows through the serpentine path between the base and the cover, such that the wastewater heats the fresh water flowing through the heat exchange coil.

2. The heat exchanger tray of claim 1, wherein the one or more protruding portions are flow-directing features.

3. The heat exchanger tray of claim 2, wherein the serpentine path and the one or more protruding portions create a wastewater flow path.

4. The heat exchanger tray of claim 1, wherein the heat exchange coil is made of copper.

5. The heat exchanger tray of claim 1, wherein wastewater enters the space created between the base and the cover via a heat chamber inlet.

6. The heat exchanger tray of claim 1, wherein wastewater exits the heat exchanger tray via a wastewater outlet.

7. The heat exchanger tray of claim 1, wherein water enters the heat exchange coil via an inlet, and wherein water heated via the wastewater exits the heat exchange coil via an outlet.

8. A heat exchanger tray comprising:
a base;
a cover positioned within the base to create a space between the cover and the base, the cover including one or more protruding portions that at least partially form a serpentine path in the space; and
a heat exchange coil positioned at least partially in the serpentine path in the space;
wherein fresh water flows through the heat exchange coil; and
wherein wastewater flows through the space along the serpentine path, and the wastewater heats the fresh water flowing through the heat exchange coil.

9. The heat exchanger tray of claim 8, wherein the base comprises a bottom portion comprising one or more sidewalls.

10. The heat exchanger tray of claim 9, wherein the protruding portions of the cover are flow-directing features that engage with one or more sidewalls of the bottom portion of the base to create the serpentine path.

11. The heat exchanger tray of claim 10, wherein the serpentine path and the one or more protruding portions create a wastewater flow path.

12. The heat exchanger tray of claim 8, wherein the heat exchange coil is made of copper.

13. The heat exchanger tray of claim 8, wherein wastewater enters the space created between the base and the cover via a heat chamber inlet.

14. The heat exchanger tray of claim 8, wherein wastewater exits the heat exchanger tray via a wastewater outlet.

15. The heat exchanger tray of claim 8, wherein water enters the heat exchange coil via an inlet, and wherein water heated via the wastewater exits the heat exchange coil via an outlet.

16. A method for manufacturing a heat exchanger tray comprising:
providing a base that includes a cutout;
placing a cover within the cutout of the base;
positioning a heat exchange coil in a space created between the base and the cover; and
connecting the heat exchange coil between a freshwater inlet and an ablutionary fitting;
wherein wastewater flows through the space created between the base and the cover, and the wastewater heats the water flowing through the heat exchange coil.

17. The method of claim 16, wherein the base comprises a bottom portion comprising one or more sidewalls forming a serpentine path.

18. The method of claim 17, wherein the cover comprises one or more protruding portions, and wherein the one or more protruding portions are flow-directing features.

19. The method of claim 18, wherein the serpentine path and the one or more protruding portions create a wastewater flow path.

20. The method of claim 16, wherein the heat exchange coil is made of copper.
